(19) United States
(12) Patent Application Publication
(10) Pub. No.: US 2022/0198289 A1
(43) Pub. Date: Jun. 23, 2022

(54) RECOMMENDATION MODEL TRAINING METHOD, SELECTION PROBABILITY PREDICTION METHOD, AND APPARATUS

(71) Applicant: HUAWEI TECHNOLOGIES CO., LTD., Shenzhen (CN)

(72) Inventors: Huifeng Guo, Shenzhen (CN); Jinkai Yu, Shenzhen (CN); Qing Liu, Shenzhen (CN); Ruiming Tang, Shenzhen (CN); Xiuqiang He, Shenzhen (CN)

(73) Assignee: HUAWEI TECHNOLOGIES CO., LTD., Shenzhen (CN)

(21) Appl. No.: 17/691,843

(22) Filed: Mar. 10, 2022

Related U.S. Application Data
(63) Continuation of application No. PCT/CN2020/114516, filed on Sep. 10, 2020.

(30) Foreign Application Priority Data
Sep. 11, 2019 (CN) 201910861011.1

(51) Int. Cl. G06N 5/02; G06N 5/04

(52) U.S. Cl. CPC G06N 5/022; G06N 5/04

(57) ABSTRACT

A recommendation model training method, a selection probability prediction method, and an apparatus are provided. The training method includes obtaining a training sample, where the training sample includes a sample user behavior log, position information of a sample recommended object, and a sample label. The training method further includes performing joint training on a position aware model and a recommendation model by the training sample, to obtain a trained recommendation model, where the position aware model predicts probabilities that a user pays attention to a target recommended object when the target recommended object is at different positions, and the recommendation model predicts, when the user pays attention to the target recommended object, a probability that the user selects the target recommended object.

### CROSS-REFERENCE TO RELATED APPLICATIONS

This application is a continuation of International Application No. PCT/CN2020/114516, filed on Sep. 10, 2020, which claims priority to Chinese Patent Application No. 201910861011.1, filed on Sep. 11, 2019. The disclosures of the aforementioned applications are hereby incorporated by reference in their entireties.

### TECHNICAL FIELD

This application relates to the field of artificial intelligence, and more specifically, to a recommendation model training method, a selection probability prediction method, and an apparatus.

### BACKGROUND

Selection rate prediction is to predict a probability that a user selects a specific commodity in a specific environment. For example, in a recommendation system of an application such as an application store or online advertising, selection rate prediction plays a key role. The selection rate prediction can maximize benefits of an enterprise and improve user satisfaction. The recommendation system needs to consider both a rate of selecting a commodity by a user and a commodity price. The selection rate is predicted by the recommendation system based on historical behaviors of the user, and the commodity price represents benefits of the system that are obtained after the commodity is selected/downloaded. For example, a function may be constructed, the function may be used to calculate function values based on predicted user selection rates and commodity prices, and the recommendation system arranges commodities in descending order of the function values.

In the recommendation system, a recommendation model may be obtained by learning a model parameter based on user-commodity interaction information (namely, implicit user feedback data). However, the implicit user feedback data is affected by a presentation position of a recommended object (for example, a recommended commodity). For example, a selection rate of a recommended commodity that ranks first in a recommendation sequence is different from a selection rate of a recommended commodity that ranks fifth in the recommendation sequence. In other words, a user selects a recommended commodity due to two factors: The user likes the recommended commodity, and the recommended commodity is recommended at a position that is more likely to draw attention. In other words, the implicit user feedback data used to train the model parameter cannot truly reflect interests and hobbies of the user. A deviation in the implicit user feedback data exists due to position information, in other words, the implicit user feedback data is affected by a recommendation position. Therefore, if the model parameter is directly trained based on the implicit user feedback data, accuracy of an obtained selection rate prediction model is relatively low.

Therefore, how to improve accuracy of the recommendation model becomes a problem that urgently needs to be resolved.

### SUMMARY

This application provides a recommendation model training method, a selection probability prediction method, and an apparatus, to eliminate impact on recommendation that is caused by position information and improve accuracy of a recommendation model.

According to a first aspect, a recommendation model training method is provided. The method includes: obtaining a training sample, where the training sample includes a sample user behavior log, position information of a sample recommended object, and a sample label, and the sample label is used to indicate whether a user selects the sample recommended object; and performing joint training on a position aware model and a recommendation model by using the sample user behavior log and the position information of the sample recommended object as input data and using the sample label as a target output value, to obtain a trained recommendation model. The position aware model is used to predict probabilities that the user pays attention to a target recommended object when the target recommended object is at different positions, and the recommendation model is used to predict, when the user pays attention to the target recommended object, a probability that the user selects the target recommended object.

It should be understood that the probability that the user selects the target recommendation may be a probability that the user clicks the target object, for example, may be a probability that the user downloads the target object, or a probability that the user browses the target object. Alternatively, the probability that the user selects the target object may be a probability that the user performs a user operation on the target object.

The recommended object may be a recommended application in an application market of a terminal device. Alternatively, a recommended object in a browser may be a recommended website or recommended news. In this embodiment of this application, the recommended object may be information recommended by a recommendation system to a user. A specific implementation of the recommended object is not limited in this application.

In this embodiment of this application, the probabilities that the user pays attention to the target recommended object at different positions may be predicted based on the position aware model, and the probability that the user selects the target recommended object, namely, the probability that the user selects the target recommended object based on interests and hobbies of the user, when the target recommended object has been seen may be predicted based on the recommendation model; and joint training may be performed by using the sample user behavior log and the position information of the sample recommended object as the input data and using the sample label as the target output value, to eliminate impact on the recommendation model that is caused by position information and obtain a recommendation model that is based on interests and hobbies of the user, so that accuracy of the recommendation model is improved.

In a possible implementation, the joint training is training model parameters of the position aware model and the recommendation model based on a difference between the sample label and a jointly predicted selection probability, and the jointly predicted selection probability is obtained based on output data of the position aware model and the recommendation model.

In this embodiment of this application, fitting may be performed on the sample label in the training sample based on the output data of the position aware model and the recommendation model, and joint training may be performed on the parameters of the position aware model and the actual user recommendation model by using the difference between the sample label and the jointly predicted selection probability, to eliminate impact on the recommendation model that is caused by position information and obtain a recommendation model that is based on interests and hobbies of the user.

In a possible implementation, the jointly predicted selection probability may be obtained by multiplying output data of the position aware model and output data of the recommendation model.

In another possible implementation, the jointly predicted selection probability may be obtained by performing weighted processing on output data of the position aware model and output data of the recommendation model.

Optionally, the joint training may be multi-task learning, and a plurality of pieces of training data use a shared representation to simultaneously learn a plurality of sub-task models. A basic assumption of multi-task learning is that a plurality of tasks are correlated, and therefore, the tasks can promote each other by using the correlation between the tasks.

Optionally, the model parameters of the position aware model and the recommendation model may be obtained through a plurality of iterations based on the difference between the sample label and the jointly predicted selection probability and by using a back propagation algorithm.

In a possible implementation, the training method further includes: inputting the position information of the sample recommended object into the position aware model to obtain the probability that the user pays attention to the target recommended object; inputting the sample user behavior log into the recommendation model to obtain the probability that the user selects the target recommended object; and obtaining the jointly predicted selection probability by multiplying the probability that the user pays attention to the target recommended object by the probability that the user selects the target recommended object.

In this embodiment of this application, the position information of the sample recommended object may be input into the position aware model to obtain the predicted probability that the user pays attention to the target recommended object; the sample user behavior log may be input into the recommendation model to obtain the predicted probability that the user selects the target recommended object; and fitting may be performed on the predicted probability that the user pays attention to the target recommended object and the predicted probability that the user selects the target recommended object, to obtain the jointly predicted selection probability, so that the model parameters of the position aware model and the recommendation model can be constantly trained by using the difference between the sample label and the jointly predicted selection probability.

In a possible implementation, the sample user behavior log includes one or more of sample user profile information, characteristic information of the sample recommended object, and sample context information.

Optionally, the user profile information may also be referred to as a crowd profile, and is a labeled profile abstracted based on information such as demographics, social relationships, preferences, habits, and consumption behaviors of the user. For example, the user profile information may include user download history information and user interest and hobby information.

Optionally, the characteristic information of the recommended object may be a category of the recommended object, or may be an identifier of the recommended object, for example, an ID of the recommended object.

Optionally, the sample context information may include historical download time information, historical download place information, or the like.

In a possible implementation, the position information of the sample recommended object is recommendation position information of the sample recommended object in different types of historical recommended objects, or the position information of the sample recommended object is recommendation position information of the sample recommended object in a same type of historical recommended object, or the position information of the sample recommended object is recommendation position information of the sample recommended object in historical recommended objects in different top lists.

Optionally, the position information of the sample recommended object may be recommendation position information of the sample recommended object in different types of recommended objects, in other words, a recommendation sequence may include a plurality of different types of objects, and the position information may be recommendation position information of an object X in the plurality of different types of recommended objects.

Optionally, the position information of the sample recommended object is recommendation position information of the sample recommended object in a same type of recommended object, in other words, position information of a recommended object X may be a recommendation position of the recommended object X in recommended objects of a category to which the recommended object X belongs.

Optionally, the position information of the sample recommended object is recommendation position information of the sample recommended object in recommended objects in different top lists.

For example, different top lists may be a user scoring top list, a today's top list, this week's top list, a nearby top list, a city top list, and a country top list.

According to a second aspect, a selection probability prediction method is provided. The method includes: obtaining user characteristic information of a to-be-processed user, context information, and a candidate recommended object set; inputting the user characteristic information, the context information, and the candidate recommended object set into a pre-trained recommendation model to obtain a probability that the to-be-processed user selects a candidate recommended object in the candidate recommended object set, where the pre-trained recommendation model is used to predict, when the user pays attention to a target recommended object, a probability that the user selects the target recommended object; and obtaining a recommendation result of the candidate recommended object based on the probability, where a model parameter of the pre-trained recommendation model is obtained by performing joint training on a position aware model and the recommendation model by using a sample user behavior log and position information of a sample recommended object as input data and using a sample label as a target output value, the position aware model is used to predict probabilities that the user pays attention to the target recommended object when the target recommended object is at different positions, and the sample label is used to indicate whether the user selects the sample recommended object.

In this embodiment of this application, the probability that the to-be-processed user selects the candidate recommended object in the candidate recommended object set may be predicted by inputting the user characteristic information of the to-be-processed user, the current context information, and the candidate recommended object set into the pre-trained recommendation model. The pre-trained recommendation model may be used to perform online inference on a probability that the user selects a recommended object based on interests and hobbies of the user. The pre-trained recommendation model can avoid a problem of a lack of input position information in a prediction phase that is caused by using position bias information as a common characteristic to train a recommendation model, in other words, can resolve a problem of complex calculation that is caused by traversing all positions and a problem of unstable prediction that is caused by selecting a default position. In this application, the pre-trained recommendation model is obtained by performing joint training on the position aware model and the recommendation model by using training data, to eliminate impact on the recommendation model that is caused by position information and obtain a recommendation model that is based on interests and hobbies of the user, so that accuracy of predicting a selection probability is improved.

In a possible implementation, the context information may include current download time information or current download place information.

Optionally, candidate recommended objects in the candidate recommended object set may be arranged based on predicted actual selection probabilities of the candidate recommended objects, to obtain recommendation results of the candidate recommended objects.

Optionally, the candidate recommended object set may include characteristic information of the candidate recommended object.

For example, the characteristic information of the candidate recommended object may be a category of the candidate recommended object, or may be an identifier of the candidate recommended object, for example, an ID of a commodity.

In a possible implementation, the joint training is training parameters of the position aware model and the recommendation model based on a difference between the actual sample label and a jointly predicted selection probability that include position information, and the jointly predicted selection probability is obtained by multiplying output data of the position aware model and output data of the recommendation model.

In this embodiment of this application, the output data of the position aware model and the output data of the recommendation model may be multiplied, to perform fitting on the predicted selection probability that is in training data and that includes position information; and joint training may be performed on the position aware model and the recommendation model by using the difference between the actual sample label and the jointly predicted selection probability, so that impact on a recommendation effect that is caused by position information can be eliminated, and a model for predicting a user selection probability based on interests and hobbies of the user is obtained.

Optionally, the joint training may be multi-task learning, and a plurality of pieces of training data use a shared representation to simultaneously learn a plurality of sub-task models. A basic assumption of multi-task learning is that a plurality of tasks are correlated, and therefore, the tasks can promote each other by using the correlation between the tasks.

Optionally, the parameters of the position aware model and the recommendation model may be obtained through a plurality of iterations based on the difference between the actual sample label including position information and the predicted selection probability including position information and by using a back propagation algorithm.

Optionally, the jointly predicted selection probability is obtained by multiplying the probability that the user pays attention to the target recommended object by the probability that the user selects the target recommended object, the probability that the user pays attention to the target recommended object is obtained based on the position information of the sample recommended object and the position aware model, and the probability that the user selects the target recommended object is obtained based on the sample user behavior and the recommendation model.

The sample user behavior log includes one or more of sample user profile information, characteristic information of the sample recommended object, and sample context information.

Optionally, the user profile information may also be referred to as a crowd profile, and is a labeled profile abstracted based on information such as demographics, social relationships, preferences, habits, and consumption behaviors of the user. For example, the user profile information may include user download history information and user interest and hobby information.

Optionally, the characteristic information of the recommended object may be a category of a commodity, or may be an identifier of a commodity, for example, an ID of the commodity.

Optionally, the sample context information may include historical download time information, historical download place information, or the like.

Optionally, the position information of the sample recommended object is recommendation position information of the sample recommended object in different types of recommended objects, or the position information of the sample recommended object is recommendation position information of the sample recommended object in a same type of recommended object, or the position information of the sample recommended object is recommendation position information of the sample recommended object in recommended objects in different top lists.

According to a third aspect, a recommendation model training apparatus is provided. The apparatus includes a module/unit configured to implement the training method in any one of the first aspect and the implementations of the first aspect.

According to a fourth aspect, a selection probability prediction apparatus is provided. The apparatus includes a module/unit configured to implement the method in any one of the second aspect and the implementations of the second aspect.

According to a fifth aspect, a recommendation model training apparatus is provided, including an input/output interface, a processor, and a memory. The processor is configured to control the input/output interface to send and receive information. The memory is configured to store a computer program. The processor is configured to invoke the computer program from the memory and run the computer program, so that the training apparatus performs the method in any one of the first aspect and the implementations of the first aspect.

Optionally, the training apparatus may be a terminal device/server, or may be a chip in the terminal device/server.

Optionally, the memory may be located in the processor, for example, may be a cache (cache) in the processor. The memory may alternatively be located outside the processor and independent of the processor, for example, may be an internal memory (memory) of the training apparatus.

According to a sixth aspect, a selection probability prediction apparatus is provided. The apparatus includes an input/output interface, a processor, and a memory. The processor is configured to control the input/output interface to send and receive information. The memory is configured to store a computer program. The processor is configured to invoke the computer program from the memory and run the computer program, so that the apparatus performs the method in any one of the second aspect and the implementations of the second aspect.

Optionally, the apparatus may be a terminal device/server, or may be a chip in the terminal deviceserver.

Optionally, the memory may be located in the processor, for example, may be a cache (cache) in the processor. The memory may alternatively be located outside the processor and independent of the processor, for example, may be an internal memory (memory) of the apparatus.

According to a seventh aspect, a computer program product is provided. The computer program product includes computer program code, and when the computer program code is run on a computer, the computer is enabled to perform the methods in the foregoing aspects.

It should be noted that some or all of the computer program code may be stored in a first storage medium. The first storage medium may be encapsulated with a processor, or may be encapsulated separately from a processor. This is not specifically limited in embodiments of this application.

According to an eighth aspect, a computer-readable medium is provided. The computer-readable medium stores program code, and when the computer program code is run on a computer, the computer is enabled to perform the methods in the foregoing aspects.

### BRIEF DESCRIPTION OF DRAWINGS

FIG. 1 is a schematic diagram of a recommendation system according to an embodiment of this application;

FIG. 2 is a schematic diagram of a structure of a system architecture according to an embodiment of this application;

FIG. 3 is a schematic diagram of a hardware structure of a chip according to an embodiment of this application;

FIG. 4 is a schematic diagram of a system architecture according to an embodiment of this application;

FIG. 5 is a schematic flowchart of a recommendation model training method according to an embodiment of this application;

FIG. 6 is a schematic diagram of a selection probability prediction framework in which position information is noticed according to an embodiment of this application;

FIG. 7 is a schematic diagram of an online inference phase of a trained recommendation model according to an embodiment of this application;

FIG. 8 is a schematic flowchart of a selection probability prediction method according to an embodiment of this application;

FIG. 9 is a schematic diagram of recommended objects in an application market according to an embodiment of this application;

FIG. 10 is a schematic block diagram of a recommendation model training apparatus according to an embodiment of this application;

FIG. 11 is a schematic block diagram of a selection probability prediction apparatus according to an embodiment of this application;

FIG. 12 is a schematic block diagram of a recommendation model training apparatus according to an embodiment of this application; and

FIG. 13 is a schematic block diagram of a selection probability prediction apparatus according to an embodiment of this application.

### DESCRIPTION OF EMBODIMENTS

The following describes technical solutions in embodiments of this application with reference to the accompanying drawings in embodiments of this application. It is clear that the described embodiments are merely some but not all of embodiments of this application. All other embodiments obtained by a person of ordinary skill in the art based on embodiments of this application without creative efforts shall fall within the protection scope of this application.

First, concepts involved in embodiments of this application are briefly described.

1. Click-Through Rate (Click-Through Rate, CTR)

The click-through rate is a ratio of a quantity of times recommended information (for example, a recommended commodity) on a website or an application is clicked to a quantity of times of exposure of the recommended information. The click-through rate is usually an important indicator for measuring a recommendation system in recommendation systems.

2. Personalized Recommendation System

The personalized recommendation system is a system that makes an analysis by using a machine learning algorithm based on historical data of a user, makes prediction for a new request, and provides a personalized recommendation result.

3. Offline Training (Offline Training)

The offline training is a module that is in the personalized recommendation system and that iteratively updates a parameter of a recommendation model by using the machine learning algorithm based on the historical data of the user until a specified requirement is met.

4. Online Inference (Online Inference)

The online inference is to predict, based on a model obtained through offline training, favorability of a user for a recommended commodity in a current context environment based on characteristics of the user, the commodity, and a context and predict a probability that the user selects the recommended commodity.

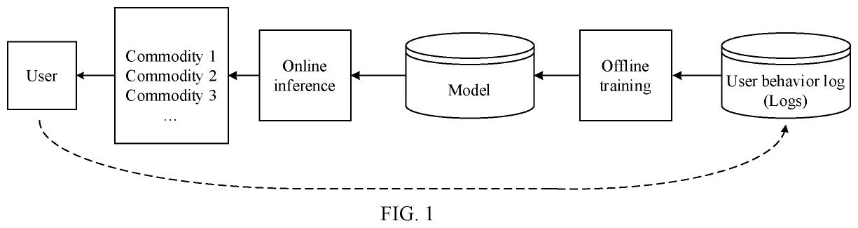

For example, FIG. 1 is a schematic diagram of a recommendation system according to an embodiment of this application. As shown in FIG. 1, when a user enters the system, a recommendation request is triggered. The recommendation system inputs the request and information about the request into a prediction model, and then predicts rates of selecting commodities in the system by the user. Further, commodities are arranged in descending order based on the predicted selection rates or a function of the selection rates, in other words, the recommendation system may sequentially present the commodities at different positions. The presentation is used as a recommendation result for the user. The user browses commodities at different positions, and user behaviors such as browsing, selecting, and downloading occur. In addition, an actual user behavior is stored in a log as training data, and a parameter of the prediction model is constantly updated by using an offline training module, to improve a prediction effect of the model.

For example, the user may trigger a recommendation system of an application market in an intelligent terminal (for example, a mobile phone) by opening the application market. The recommendation system of the application market predicts, based on a historical behavior log of the user, for example, a historical download record of the user and a user selection record, and characteristics of the application market, for example, environment characteristic information such as time and a place, probabilities that the user downloads candidate recommended applications (application, APP). Based on a calculated result, the recommendation system of the application market may present the candidate APPs in descending order of values of the predicted probabilities, to improve a download probability of the candidate APP.

For example, an APP with a relatively high predicted user selection rate may be presented at a front recommendation position, and an APP with a relatively low predicted user selection rate may be presented in a back recommendation position.

The recommendation model in the offline training and the online inference model may be neural network models. The following describes related terms and concepts of a neural network that may be involved in embodiments of this application.

5. Neural Network

The neural network may include a neuron. The neuron may be an operation unit that uses xs and an intercept of 1 as input. Output of the operation unit may be as follows:

$${h}_{W , b} ( x ) = f ( {W}^{T} x ) = f ( {\sum }_{s = 1}^{n} {W}_{s} {x}_{s} + b ) .$$

Herein, s=1, 2, . . . , n, n is a natural number greater than 1, Wₛ represents a weight of xₛ, b represents a bias of the neuron, and ƒ represents an activation function (activation functions) of the neuron, where the activation function is used to introduce a non-linear characteristic into the neural network, to convert an input signal in the neuron into an output signal. The output signal of the activation function may be used as input of a next convolutional layer, and the activation function may be a sigmoid function. The neural network is a network constituted by connecting a plurality of single neurons together. To be specific, output of a neuron may be input of another neuron. Input of each neuron may be connected to a local receptive field of a previous layer to extract a feature of the local receptive field. The local receptive field may be a region including several neurons.

6. Deep Neural Network

The deep neural network (deep neural network, DNN) is also referred to as a multi-layer neural network, and may be understood as a neural network having a plurality of hidden layers. The DNN is divided based on positions of different layers. Neural networks inside the DNN may be classified into three types: an input layer, a hidden layer, and an output layer. Generally, the first layer is the input layer, the last layer is the output layer, and the middle layer is the hidden layer. Layers are fully connected. To be specific, any neuron in an i^{th} layer is necessarily connected to any neuron in an (i+1)th layer.

Although the DNN seems complex, work of each layer is actually not complex, and is simply expressed by the following linear relational expression: \vec{y}=α(W\vec{x}+\vec{b}). \vec{x} represents an input vector, \vec{y} represents an output vector, \vec{b} represents a bias vector, W represents a weight matrix (which is also referred to as a coefficient), and α( ) represents an activation function. At each layer, the output vector \vec{y} is obtained by performing such a simple operation only on the input vector \vec{x}. Due to a large quantity of DNN layers, quantities of coefficients W and bias vectors \vec{b} are also large. These parameters are defined in the DNN as follows: Using the coefficient W as an example, it is assumed that in a three-layer DNN, a linear coefficient from a fourth neuron in a second layer to a second neuron in a third layer is defined as W₂₄³. A superscript 3 represents a number of a layer in which the coefficient W is located, and a subscript corresponds to an index 2 of the third layer for output and an index 4 of the second layer for input.

In conclusion, a coefficient from a k^{th} neuron in an (L−1)^{th} layer to a j^{th} neuron in an L^{th} layer is defined as Wⱼₖ^{L}.

It should be noted that the input layer has no parameter W. In the deep neural network, more hidden layers make the network more capable of describing a complex case in the real world.

Theoretically, a model with more parameters has higher complexity and a larger “capacity”. It indicates that the model can complete a more complex learning task. Training of the deep neural network is a process of learning a weight matrix, and a final objective of the training is to obtain a weight matrix of all layers of a trained deep neural network (a weight matrix formed by vectors W of many layers).

7. Loss Function

In a process of training a deep neural network, because it is expected that an output of the deep neural network is as close as possible to a value that is actually expected to be predicted, a current predicted value of the network may be compared with a target value that is actually expected, and then a weight vector at each layer of the neural network is updated based on a difference between the current predicted value and the target value (there is usually an initialization process before the first update, that is, a parameter is preconfigured for each layer of the deep neural network). For example, if the predicted value of the network is large, the weight vector is adjusted to lower the predicted value until the deep neural network can predict the target value that is actually expected or a value close to the target value that is actually expected. Therefore, “how to obtain, through comparison, the difference between the predicted value and the target value” needs to be predefined. This is the loss function (loss function) or an objective function (objective function). The loss function and the objective function are important equations used to measure the difference between the predicted value and the target value. The loss function is used as an example. A higher output value (loss) of the loss function indicates a larger difference. Therefore, training of the deep neural network is a process of minimizing the loss as much as possible.

8. Back Propagation Algorithm

In a training process, a neural network may correct values of parameters in an initial neural network model by using an error back propagation (back propagation, BP) algorithm, so that a reconstruction error loss of the neural network model becomes smaller. Specifically, an input signal is forward transferred until an error loss occurs in output, and the parameters in the initial neural network model are updated based on back propagation error loss information, so that the error loss is reduced. The back propagation algorithm is a back propagation motion mainly dependent on the error loss, and aims to obtain parameters of an optimal neural network model, for example, a weight matrix.

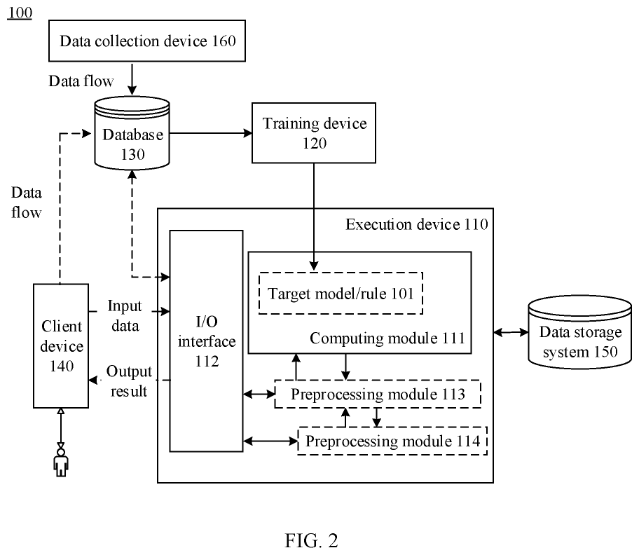

FIG. 2 shows a system architecture 100 according to an embodiment of this application.

In FIG. 2, a data collection device 160 is configured to collect training data. For the recommendation model training method in embodiments of this application, a recommendation model may be further trained by using a training sample, in other words, the training data collected by the data collection device 160 may be a training sample.

For example, in this embodiment of this application, the training sample may include a sample user behavior log, position information of a sample recommended object, and a sample label. The sample label may be used to indicate whether a user selects the sample recommended object.

The data collection device 160 stores the training data in a database 130 after collecting the training data, and a training device 120 obtains a target model/rule 101 through training based on the training data maintained in the database 130.

The following describes the target model/rule 101 obtained by the training device 120 based on the training data. The training device 120 processes an input raw image, and compares an output image with the raw image until a difference between the image output by the training device 120 and the raw image is less than a specific threshold. In this way, training of the target model/rule 101 is completd.

For example, in this embodiment of this application, the training device 120 may perform joint training on a position aware model and the recommendation model based on the training sample. For example, the training device 120 may perform joint training on the position aware model and the recommendation model by using the sample user behavior log and the position information of the sample recommended object as input data and using the sample label as a target output value, to obtain a trained recommendation model. The trained recommendation model may be the target model/rule 101.

The target model/rule 101 can be used to predict, when the user pays attention to a target recommended object, a probability that the user selects the target recommended object. The target model/rule 101 in this embodiment of this application may be specifically a neural network, a logistic regression model, or the like.

It should be noted that, in actual application, the training data maintained in the database 130 may not all be collected by the data collection device 160, or may be received and obtained from another device. It should be further noted that the training device 120 may not necessarily train the target model/rule 101 completely based on the training data maintained in the database 130, or may obtain training data from a cloud or another place to perform model training. The foregoing description should not be construed as a limitation on embodiments of this application.

The target model/rule 101 obtained through training by the training device 120 may be applied to different systems or devices, for example, an execution device 110 shown in FIG. 2.

The execution device 110 may be a terminal, for example, a mobile phone terminal, a tablet, a laptop computer, an augmented reality (augmented reality, AR)/virtual reality (virtual reality, VR) terminal, or a vehicle-mounted terminal, or may be a server, a cloud, or the like. In FIG. 2, the execution device 110 is provided with the input/output (input/output, I/O) interface 112, configured to exchange data with an external device. A user may input data to the I/O interface 112 through the client device 140. The input data in this embodiment of this application may include a training sample input through the client device.

A preprocessing module 113 and a preprocessing module 114 are configured to perform preprocessing based on the input data (for example, the to-be-processed image) received through the I/O interface 112. In this embodiment of this application, the preprocessing module 113 and the preprocessing module 114 may not exist (or only one of the preprocessing module 113 and the preprocessing module 114 exists). The input data is directly processed by a computing module 111.

In a process in which the execution device 110 preprocesses the input data or the computing module 111 of the execution device 110 performs related processing such as calculation, the execution device 110 may invoke data, code, and the like in a data storage system 150 for corresponding processing, and may also store data, instructions, and the like obtained through corresponding processing into the data storage system 150.

Finally, the I/O interface 112 may return a processing result to the client device 140, so that the processing result is provided to the user. For example, the obtained trained recommendation model may be used by the recommendation system to perform online inference on a probability that a to-be-processed user selects a candidate recommended object in a candidate recommended object set, and a recommendation result of the candidate recommended object may be obtained based on the probability that the to-be-processed user selects the candidate recommended object.

For example, in this embodiment of this application, the recommendation result may be a recommendation sequence of candidate recommended objects that is obtained based on probabilities of selecting the candidate recommended objects by the to-be-processed user.

It should be noted that the training device 120 may generate corresponding target models/rules 101 for different targets or different tasks based on different training data. The corresponding target models/rules 101 may be used to implement the foregoing targets or complete the foregoing tasks, to provide a desired result for the user.

In a case shown in FIG. 2, the user may manually provide the input data. The manual provision may be performed in a user interface provided by the I/O interface 112.

In another case, the client device 140 may automatically send input data to the I/O interface 112. If it is required that the client device 140 obtain authorization from the user to automatically send the input data, the user may set corresponding permission on the client device 140. The user may view, on the client device 140, a result output by the execution device 110. Specifically, the result may be presented in a form of displaying, a sound, an action, or the like. The client device 140 may also serve as a data collection end to collect, as new sample data, input data that is input into the I/O interface 112 and an output result that is output from the I/O interface 112 that are shown in the figure, and store the new sample data into the database 130. Certainly, the client device 140 may alternatively not perform collection, but the I/O interface 112 directly stores, as the new sample data into the database 130, the input data that is input into the I/O interface 112 and the output result that is output from the I/O interface 112 that are shown in the figure.

It should be noted that FIG. 2 is merely a schematic diagram of the system architecture according to an embodiment of this application. A position relationship between a device, a component, a module, and the like shown in the figure constitutes no limitation. For example, in FIG. 2, the data storage system 150 is an external memory relative to the execution device 110. In another case, the data storage system 150 may alternatively be disposed in the execution device 110.

For example, the recommendation model in this application may be a fully convolutional network (fully convolutional network, FCN).

For example, the recommendation model in this embodiment of this application may alternatively be a logistic regression (logistic regression) model. The logistic regression model is a machine learning method used to resolve a classification problem, and may be used to estimate a possibility for a specific item.

For example, the recommendation model may be a deep factorization machines (deep factorization machines, DFM) model, or the recommendation model may be a wide & deep (wide & deep) model.

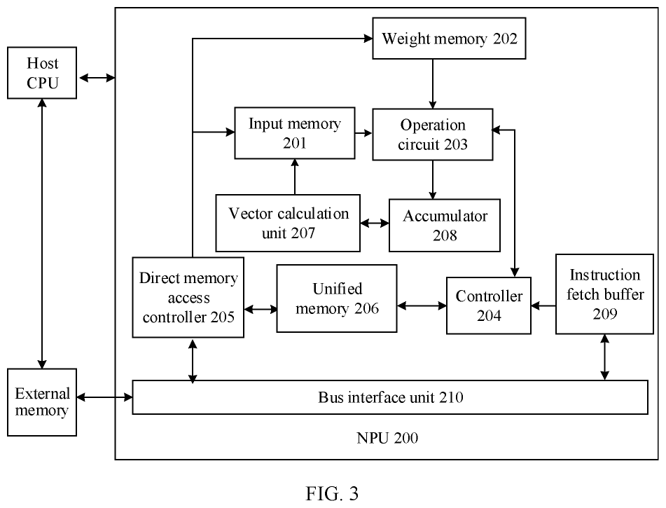

FIG. 3 shows a hardware structure of a chip according to an embodiment of this application. The chip includes a neural-network processing unit 200. The chip may be disposed in the execution device 110 shown in FIG. 2, so as to complete calculation work of the computing module 111. The chip may alternatively be disposed in the training device 120 shown in FIG. 2, so as to complete training work of the training device 120 and output a target model/rule 101.

The neural-network processing unit (neural-network processing unit, NPU) 200 is mounted to a host central processing unit (host central processing unit, Host CPU) as a co-processor, and the host CPU allocates tasks. A core part of the NPU 200 is an operation circuit 203, and a controller 204 controls the operation circuit 203 to extract data in a memory (a weight memory or an input memory) and perform an operation.

In some implementations, the operation circuit 203 includes a plurality of processing engines (process engine, PE). In some implementations, the operation circuit 203 is a two-dimensional systolic array. The operation circuit 203 may alternatively be a one-dimensional systolic array or another electronic circuit that can perform arithmetical operations such as multiplication and addition. In some implementations, the operation circuit 203 is a general-purpose matrix processor.

For example, it is assumed that there are an input matrix A, a weight matrix B, and an output matrix C. The operation circuit 203 fetches data corresponding to the matrix B from a weight memory 202 and buffers the data on each PE in the operation circuit 203. The operation circuit 203 fetches data of the matrix A from an input memory 201, to perform a matrix operation with the matrix B to obtain a partial result or a final result of a matrix, and stores the result into an accumulator (accumulator) 208.

A vector calculation unit 207 may perform further processing such as vector multiplication, vector addition, an exponent operation, a logarithm operation, or value comparison on an output of the operation circuit 203.

For example, the vector calculation unit 207 may be configured to perform network calculation, such as pooling (pooling), batch normalization (batch normalization), or local response normalization (local response normalization), at a non-convolution/non-FC layer in a neural network.

In some implementations, the vector calculation unit 207 can store, in a unified memory 206, an output vector that has been processed. For example, the vector calculation unit 207 may apply a non-linear function to the output of the operation circuit 203, for example, to a vector of an accumulated value, so as to generate an activation value. In some implementations, the vector calculation unit 207 generates a normalized value, a combined value, or both.

In some implementations, the output vector that has been processed can be used as an activation input of the operation circuit 203, for example, to be used in a subsequent layer in the neural network.

The unified memory 206 is configured to store input data and output data. For weight data, a direct memory access controller (direct memory access controller, DMAC) 205 stores input data in an external memory into the input memory 201 and/or the unified memory 206, stores weight data in the external memory into the weight memory 202, and stores data in the unified memory 206 into the external memory.

A bus interface unit (bus interface unit, BIU) 210 is configured to implement interaction between the host CPU, the DMAC, and an instruction fetch buffer 209 by using a bus.

The instruction fetch buffer (instruction fetch buffer) 209 connected to the controller 204 is configured to store instructions to be used by the controller 204.

The controller 204 is configured to invoke the instructions buffered in the instruction fetch buffer 209, to control a working process of the operation accelerator.

Generally, the unified memory 206, the input memory 201, the weight memory 202, and the instruction fetch buffer 209 each are an on-chip (On-Chip) memory. The external memory is a memory outside the NPU. The external memory may be a double data rate synchronous dynamic random access memory (double data rate synchronous dynamic random access memory, DDR SDRAM for short), a high bandwidth memory (high bandwidth memory, HBM), or another readable and writable memory.

It should be noted that operations of all layers in the convolutional neural network shown in FIG. 2 may be performed by the operation circuit 203 or the vector calculation unit 207.

Currently, to eliminate impact on a recommendation model that is caused by position information, a method for performing weighted processing on training data or a method for performing modeling by using position information as a characteristic may be usually used. In the method for performing weighted processing on training data, because a weight value remains unchanged, the weight value is not dynamically adjusted based on a user or different types of commodities, and consequently, a predicted actual user selection probability is inaccurate. In the method for performing modeling by using position information as a characteristic, the position information may be used as a characteristic for training a model parameter. However, when the position information is used as the characteristic for training the model parameter, the input position characteristic cannot be obtained during selection probability prediction. Two solutions can resolve the problem, and the solutions are traversing all positions and selecting a default position. The traversing all positions has high time complexity and does not meet a system requirement of a low delay. The selecting a default position can resolve the problem of high time complexity in traversing all the positions, but affects a recommendation sequence for different default positions, and therefore affects a recommendation effect of a recommended commodity.

In view of this, this application provides a recommendation model training method, a selection probability prediction method, and an apparatus. In embodiments of this application, joint training may be performed on a position aware model and a recommendation model by using a sample user behavior log and position information of a sample recommended object as input data and using a sample label as a target output value, to obtain a trained recommendation model. The position aware model is used to predict probabilities that a user pays attention to a recommended object at different positions, so that when the user pays attention to the recommended object, a probability that the user selects the recommended object based on interests and hobbies of the user can be further predicted, thereby eliminating impact on the recommendation model that is caused by position information and improving accuracy of the recommendation model.

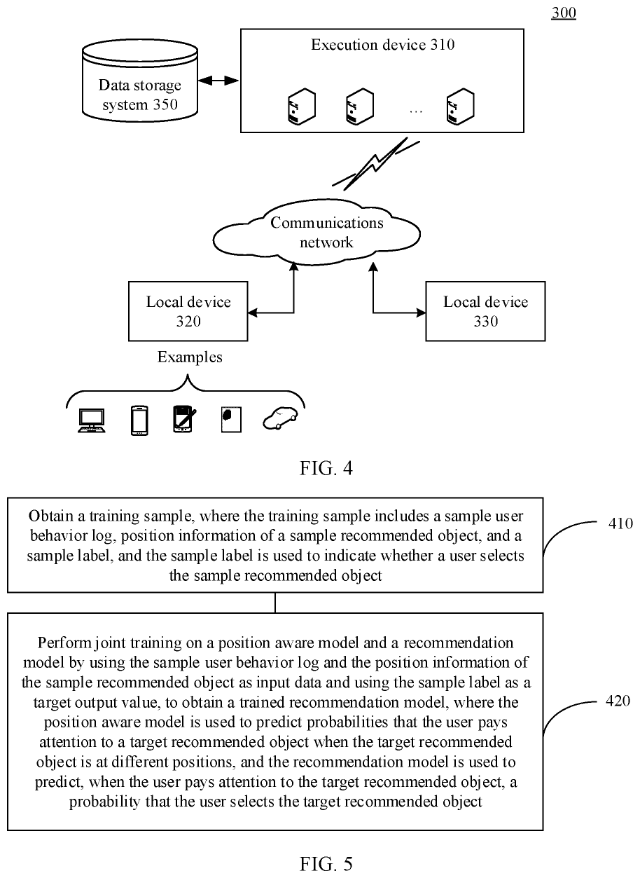

FIG. 4 shows a system architecture to which the recommendation model training method and the selection probability prediction method in embodiments of this application are applied. The system architecture 300 may include a local device 320, a local device 330, an execution device 310, and a data storage system 350. The local device 320 and the local device 330 are connected to the execution device 310 through a communication network.

The execution device 310 may be implemented by one or more servers. Optionally, the execution device 310 may cooperate with another computing device, for example, a device such as a data memory, a router, or a load balancer. The execution device 310 may be disposed on one physical site, or distributed on a plurality of physical sites. The execution device 310 may use data in the data storage system 350 or invoke program code in the data storage system 350 to implement the recommendation model training method and the selection probability prediction method in embodiments of this application.

For example, the data storage system 350 may be deployed in the local device 320 or the local device 330. For example, the data storage system 350 may be configured to store a user behavior log.

It should be noted that the execution device 310 may also be referred to as a cloud device. In this case, the execution device 310 may be deployed on the cloud.

Specifically, the execution device 310 may perform the following process: obtaining a training sample, where the training sample includes a sample user behavior log, position information of a sample recommended object, and a sample label; and performing joint training on a position aware model and a recommendation model by using the sample user behavior log and the position information of the sample recommended object as input data and using the sample label as a target output value, to obtain a trained recommendation model, where the position aware model is used to predict probabilities that a user pays attention to a target recommended object when the target recommended object is at different positions, and the recommendation model is used to predict, when the user pays attention to the target recommended object, a probability that the user selects the target recommended object.

Through the foregoing process, the execution device 310 can obtain the actual user rate recommendation model through training. The recommendation model can eliminate impact on the user that is caused by a recommendation position and predict the probability that the user selects the recommended object based on interests and hobbies of the user.

In a possible implementation, the foregoing training method of the execution device 310 may be an offline training method performed on the cloud.

After users operate respective user equipment (for example, the local device 320 and the local device 330), the users may store operation logs in the data storage system 350, and the execution device 310 may invoke the data in the data storage system 350 to complete a recommendation model training process. Each local device may be any computing device, such as a personal computer, a computer workstation, a smartphone, a tablet, an intelligent camera, a smart automobile, another type of cellular phone, a media consumption device, a wearable device, a set-top box, or a game console.

The local device of each user may interact with the execution device 310 through a communication network of any communication mechanism/communication standard. The communication network may be a wide area network, a local area network, a point-to-point connection, or any combination thereof

In an implementation, the local device 320 and the local device 730 may obtain a related parameter of a pre-trained recommendation model from the execution device 310, deploy the recommendation model on the local device 320 and the local device 330, and predict, by using the recommendation model, a probability that a user selects a recommended object.

In another implementation, a pre-trained recommendation model may be directly deployed on the execution device 310. The execution device 310 obtains a user behavior log of a to-be-processed user from the local device 320 and the local device 330, and obtains, based on the pre-trained recommendation model, a probability that the to-be-processed user selects a candidate recommended object in a candidate recommended object set.

For example, the data storage system 350 may be deployed in the local device 320 or the local device 330, and is configured to store a user behavior log of the local device.

For example, the data storage system 350 may be independent of the local device 320 or the local device 330, and is independently deployed on a storage device. The storage device may interact with the local device, obtain a user behavior log in the local device, and store the user behavior log into the storage device.

The following first describes the recommendation model training method in embodiments of this application in detail with reference to FIG. 5. A method 400 shown in FIG. 5 includes step 410 and step 420. The following separately describes step 410 and step 420 in detail.

Step 410: Obtain a training sample, where the training sample includes a sample user behavior log, position information of a sample recommended object, and a sample label, and the sample label is used to indicate whether a user selects the sample recommended object.

The training sample may be data obtained from the data storage system 350 shown in FIG. 4.

Optionally, the sample user behavior log may include one or more of user profile information of the user, characteristic information of a recommended object (for example, a recommended commodity), and sample context information.

For example, the user profile information may also be referred to as a crowd profile, and is a labeled profile abstracted based on information such as demographics, social relationships, preferences, habits, and consumption behaviors of the user. For example, the user profile information may include user download history information and user interest and hobby information.

For example, the characteristic information of the recommended object may be a category of the recommended object, or may be an identifier of the recommended object, for example, an ID of a historical recommended object.

For example, the sample context information may be historical download time information or historical download place information of a sample user.

For example, one piece of training sample data may include context information (for example, time), position information, user information, and commodity information.

For example, a user A selects/does not select a commodity X at a position 1 at 10 o'clock in the morning. The position 1 may be position information of the recommended commodity in a recommendation sequence. For the sample label, selecting the commodity X is represented by 1, and not selecting the commodity X is represented by 0; or for the sample label, another value may be used to represent selecting/not selecting the commodity X.

In a possible implementation, the position information of the sample recommended object is recommendation position information of the sample recommended object in different types of historical recommended objects, or the position information of the sample recommended object is recommendation position information of the sample recommended object in a same type of historical recommended object, or the position information of the sample recommended object is recommendation position information of the sample recommended object in historical recommended objects in different top lists.

For example, the recommendation sequence includes position 1-commodity X (category A), position 2-commodity Y (category B), and position 3-commodity Z (category C), for example, position 1-first APP (category: shopping), position 2-second APP (category: video player), and position 3-third APP (category: browser).

In a possible implementation, the position information of the sample recommendation is recommendation position information in a same type of recommended commodity. In other words, position information of the commodity X may be a recommendation position of the commodity X in commodities of a category to which the commodity X belongs.

For example, the recommendation sequence includes position 1-first APP (category: shopping), position 2-second APP (category: shopping), and position 3-third APP (category: shopping).

In a possible implementation, the position information of the sample recommended object is recommendation position information in recommended commodities in different top lists.

For example, different top lists may be a user scoring top list, a today's top list, this week's top list, a nearby top list, a city top list, and a country top list.

Step 420: Perform joint training on a position aware model and a recommendation model by using the sample user behavior log and the position information of the sample recommended object as input data and using the sample label as a target output value, to obtain a trained recommendation model, where the position aware model is used to predict probabilities that the user pays attention to a target recommended object when the target recommended object is at different positions, and the recommendation model is used to predict, when the user pays attention to the target recommended object, a probability that the user selects the target recommended object.

It should be understood that the probability that the user selects the target recommendation may be a probability that the user clicks the target object, for example, may be a probability that the user downloads the target object, or a probability that the user browses the target object. Alternatively, the probability that the user selects the target object may be a probability that the user performs a user operation on the target object.

The recommended object may be a recommended application in an application market of a terminal device. Alternatively, a recommended object in a browser may be a recommended website or recommended news. In this embodiment of this application, the recommended object may be information recommended by a recommendation system to a user. A specific implementation of the recommended object is not limited in this application.

It should be noted that the joint training may be multi-task learning, and a plurality of pieces of training data use a shared representation to simultaneously learn a plurality of sub-task models. A basic assumption of multi-task learning is that a plurality of tasks are correlated, and therefore, the tasks can promote each other by using the correlation between the tasks.

For example, in this application, obtaining the sample label is affected by two factors, namely, whether the user likes a recommended commodity and whether the recommended commodity is recommended at a position that is more likely to draw attention. In other words, the sample label means that the user selects/does not select a recommended object based on interests and hobbies of the user when the user has seen the recommended object. In other words, a probability that the user selects the recommended object may be considered as a probability that the user selects the recommended object based on the interests and the hobbies of the user when the user pays attention to the recommended object.

Optionally, the joint training may be training parameters of the position aware model and the actual user recommendation model based on a difference between the actual sample label and a j ointly predicted selection probability that include position information. The jointly predicted selection probability is obtained by multiplying output data of the position aware model and output data of the recommendation model. For example, the model parameters of the position aware model and the recommendation model may be obtained through a plurality of iterations based on the difference between the sample label and the jointly predicted selection probability and by using a back propagation algorithm. The jointly predicted selection probability may be obtained based on the output data of the position aware model and the recommendation model.

It should be understood that, in this embodiment of this application, the sample label may be a label that is about selecting a sample object by the user and that includes position information, and the jointly predicted selection probability may be a predicted probability that includes position information and that the user selects the sample object. For example, the jointly predicted selection probability may be used to indicate a probability that the user pays attention to a recommended object and selects the recommended object based on interests and hobbies of the user.

For example, the position information of the sample recommended object may be input into the position aware model to obtain the probability that the user pays attention to the target recommended object; the sample user behavior log may be input into the recommendation model to obtain the probability that the user selects the target recommended object; and the jointly predicted selection probability may be obtained by multiplying the probability that the user pays attention to the target recommended object by the probability that the user selects the target recommended commodity.

The probability that the user pays attention to the target recommended object may be the predicted selection probabilities for different positions, and may indicate a probability that the user pays attention to the recommended commodity at the position. The probabilities that the user pays attention to the recommended commodity at the different positions may be different. The probability that the user selects the target recommended object may be an actual user selection probability, namely, a probability that the user selects the recommended object based on interests and hobbies of the user. A result of multiplying the predicted selection probabilities for the different positions by the predicted actual user selection probability is the jointly predicted selection probability. The jointly predicted selection probability may be used to indicate that the user pays attention to the recommended object and selects the recommended object based on the interests and the hobbies of the user.

It should be noted that the sample label included in the training sample depends on two conditions: a condition 1: a probability that the recommended commodity is seen by the user; and a condition 2: a probability that the user selects the recommended commodity when the recommended commodity has been seen by the user.

For example, the user selects the recommended commodity depending on two conditions:

$$p ( y = 1 \vert x , pos ) = p ( seen \vert x , pos ) p ( y = 1 \vert x , pos , seen ) .$$

It is assumed that the probability that the recommended commodity is seen is related only to a position at which the commodity is presented, and the probability that the recommended commodity is selected when the recommended commodity has been seen by the user is unrelated to the position, that is,

$$p ( y = 1 \vert x , pos ) = p ( seen \vert pos ) p ( y = 1 \vert x , seen ) ,$$

where

p(y=1|x,pos) indicates the probability that the user selects the recommended commodity, x indicates the user behavior log, and pos indicates the position information, p(seen|pos) indicates the probabilities that the user pays attention to the recommended commodities at different positions, p(y=1|x, seen) indicates the probability that the recommended commodity is selected when the recommended commodity has been seen by the user, namely, a probability that the user selects the recommended commodity based on interests and hobbies of the user when the recommended commodity has been seen by the user.

In this embodiment of this application, the probabilities that the user pays attention to the target recommended object at different positions may be predicted based on the position aware model, and the probability that the user selects the target recommended object, namely, the probability that the user selects the target recommended object based on interests and hobbies of the user, when the target recommended object has been seen may be predicted based on the recommendation model; and joint training may be performed by using the sample user behavior log and the position information of the sample recommended object as the input data and using the sample label as the target output value, to eliminate impact on the recommendation model that is caused by position information and obtain a recommendation model that is based on interests and hobbies of the user, so that accuracy of the recommendation model is improved.

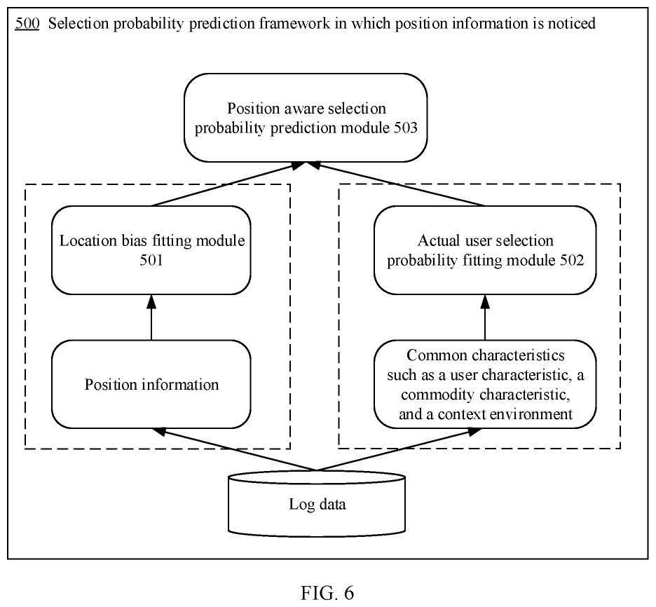

FIG. 6 shows a selection rate (also referred to as a selection probability) prediction framework in which position information is noticed according to an embodiment of this application. As shown in FIG. 6, a selection rate prediction framework 500 includes a position bias fitting module 501, an actual user selection rate fitting module 502, and a position aware user selection rate fitting module 503. In the selection rate prediction framework 500, fitting may be respectively performed on a position bias and an actual user selection rate by using the position bias fitting module 501 and the actual user selection rate fitting module 502, to accurately model obtained user behavior data, so that impact of the position bias is eliminated, and an accurate actual user selection rate fitting module 503 is finally obtained.

It should be noted that the position bias fitting module 501 may correspond to the position aware model in FIG. 5, and the actual user selection rate fitting module 502 may correspond to the recommendation model in FIG. 5. For example, the position bias fitting module 501 may be configured to predict probabilities that a user pays attention to a target recommended object when the target recommended object is at different positions, and the actual user selection rate fitting module 502 may be configured to predict, when the user pays attention to the target recommended object, a probability that the user selects the target recommended object, namely, an actual user selection rate.

Input of the framework 500 shown in FIG. 6 includes common characteristics and position bias information. The common characteristics may include a user characteristic, a commodity characteristic, and an environment characteristic. Output may include intermediate output and final output. For example, output of the module 501 and the module 502 may be considered as the intermediate output, and output of the module 503 may be considered as the final output.

It should be understood that the position bias fitting module 501 may be the position aware model shown in FIG. 5, and the actual user selection rate fitting module 502 may be the recommendation model shown in FIG. 5.

Specifically, the module 501 outputs a position information-based selection rate, the module 502 outputs the actual user selection rate, and the module 503 outputs a position aware probability that is of a user selection behavior and that is predicted by the framework 500. A higher predicted value output by the module 503 may indicate a higher predicted selection probability in the condition, and a lower predicted value output by the module 503 may indicate a lower predicted selection probability in the condition.

It should be understood that the foregoing jointly predicted selection probability may be the predicted position aware probability that is of the user selection behavior and that is output by the module 503.

The following describes the modules in the framework 500 in detail.

The position bias fitting module 501 may be configured to predict probabilities that the user pays attention to the recommended object (for example, a recommended commodity) at different positions.

For example, the module 501 uses position bias information as input, and outputs a predicted probability that the commodity is selected under the position bias condition.

The position bias information may be position information, for example, position information of the recommended commodity in a recommendation sequence.

For example, the position bias may be recommendation position information of the recommended commodity in different types of recommended commodities, or the position bias may be recommendation position information of the recommended commodity in a same type of recommended commodity, or the position bias may be recommendation position information of the recommended commodity in different top lists.

The actual user selection rate fitting module 502 is configured to predict a probability that the user selects the recommended object (for example, a recommended commodity) based on interests and hobbies of the user, in other words, the actual user selection rate fitting module 502 may be configured to predict a probability that the user selects the recommended object based on interests and hobbies of the user when the user pays attention to the recommended object.

For example, the module 502 may predict the actual user selection rate by using the common characteristics, namely, the user characteristic, the commodity characteristic, and the environment characteristic. The position aware user selection rate fitting module 503 is configured to: receive output data of the position bias fitting module 501 and the actual user selection rate fitting module 502, and multiply the output data to obtain a position aware user selection rate.

For example, the selection rate prediction framework 500 may include two phases: an offline training phase and an online inference phase. The following separately describes the offline training phase and the online inference phase in detail.

Offline training phase:

The position aware user selection rate fitting module 503 obtains the output data of the module 501 and the module 502 to calculate the position aware user selection rate, and performs fitting on the user behavior data by using the following equation:

$$L ( {θ}_{p s} , {θ}_{pCTR} ) = \frac{1}{N} {\sum }_{i = 1}^{N} l ( {y}_{i} , {bCTR}_{i} ) = \frac{1}{N} {\sum }_{i = 1}^{N} l ( {y}_{i} , {ProbSeen}_{i} \times {pCTR}_{i} ) ,$$

where

θₚₛ represents a parameter of the module 501, θ_{pCTR} represents a parameter of the module 502, N is a quantity of training samples, bCTRᵢ represents data output by the module 503 based on the i^{th} training sample, ProbSeenᵢ represents output data output by the module 501 based on the i^{th} training sample, pCTRᵢ represents output data output by the module 502 based on the i^{th} training sample, yᵢ is a label of a user behavior of the i^{th} training sample (a positive example is 1, and a negative example is 0), and l represents a loss function, namely, Logloss.

For example, parameters may be updated by using a sampling gradient descent method or a chain rule:

$${θ}_{p s}^{K + 1} = {θ}_{p s}^{K} - η \cdot \frac{1}{N} {{\sum }^{N}}_{i = 1} ( {bCTR}_{i} - {y}_{i} ) \cdot {bCTR}_{i} \cdot \frac{\partial {ProbSeen}_{i}}{\partial {θ}_{p s}^{K}} ; and$$

$${θ}_{p CTR}^{K + 1} = {θ}_{p CTR}^{K} - η \cdot \frac{1}{N} {{\sum }^{N}}_{i = 1} ( {bCTR}_{i} - {y}_{i} ) \cdot {ProbSeen}_{i} \cdot \frac{\partial {pCTR}_{i}}{\partial {θ}_{pCTR}^{K}} ,$$

where

K represents a quantity of iterations of updating the model parameter, and η represents a learning rate of updating the model parameter.

After the update of the model parameter is converged, the position aware selection rate prediction module 501 and the actual user selection rate module 502 may be obtained.

For example, the module 501 may be a linear model or a depth model based on complexity of the input position bias information.

For example, the module 502 may be a logical regression model, or may be a deep neural network model.

In this embodiment of this application, a probability that a to-be-processed user selects a candidate recommended object in a candidate recommended object set may be predicted by inputting a user behavior log of the to-be-processed user and the candidate recommended object set into a pre-trained recommendation model. The pre-trained recommendation model may be used to perform online inference on a probability that the user selects a recommended commodity based on interests and hobbies of the user. The pre-trained recommendation model can avoid a problem of a lack of input position information in a prediction phase that is caused by using position bias information as a common characteristic to train a recommendation model, in other words, can resolve a problem of complex calculation that is caused by traversing all positions and a problem of unstable prediction that is caused by selecting a default position. In this application, the pre-trained recommendation model is obtained by performing joint training on a position aware model and the recommendation model by using training data, to eliminate impact on the recommendation model that is caused by position information and obtain a recommendation model that is based on interests and hobbies of the user, so that accuracy of predicting a selection probability is improved.

Online inference phase:

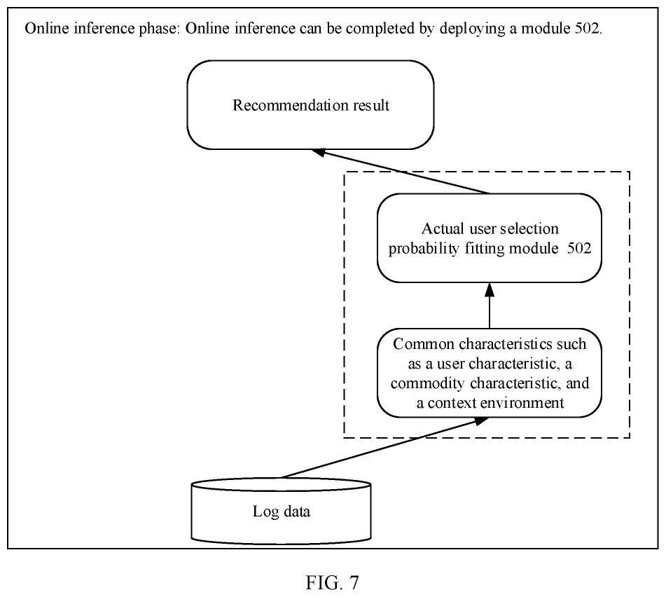

As shown in FIG. 7, only the module 502 may need to be deployed. A recommendation system constructs an input vector that is based on common characteristics such as a user characteristic, a commodity characteristic, and context information, and does not need to input a position characteristic. The module 502 can predict an actual user selection rate, namely, a probability that the user selects a recommended commodity based on interests and hobbies of the user.

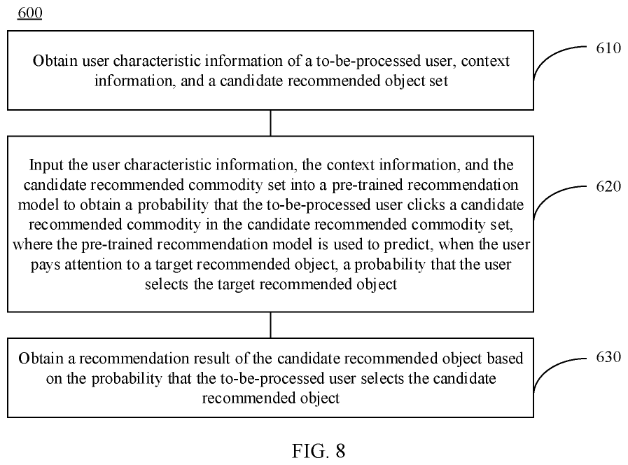

FIG. 8 is a schematic flowchart of a selection probability prediction method according to an embodiment of this application. A method 600 shown in FIG. 8 includes step 610 to step 630.

The following separately describes step 610 to step 630 in detail.

Step 610: Obtain user characteristic information of a to-be-processed user, context information, and a candidate recommended object set.

A user behavior log may be data obtained from the data storage system 350 shown in FIG. 4.

Optionally, the candidate recommended object set may include characteristic information of a candidate recommended object.

For example, the characteristic information of the candidate recommended object may be a category of the candidate recommended object, or may be an identifier of the candidate recommended object, for example, an ID of a commodity.

Optionally, the user behavior log may include user profile information and context information of the user. For example, the user profile information may also be referred to as a crowd profile, and is a labeled profile abstracted based on information such as demographics, social relationships, preferences, habits, and consumption behaviors of the user. For example, the user profile information may include user download history information and user interest and hobby information.

For example, the context information may include current download time information or current download place information.

For example, one piece of training sample data may include context information (for example, time), position information, user information, and commodity information, for example, a user B selects/does not select a commodity X at a position 2 at 10 o'clock in the morning. The position 2 may be position information of a recommended commodity in a recommendation sequence, selecting the recommended commodity may be represented by 1, and not selecting the recommended commodity may be represented by 0.

Step 620: Input the user characteristic information, the context information, and the candidate recommended object set into a pre-trained recommendation model to obtain a probability that the to-be-processed user selects a candidate recommended object in the candidate recommended object set, where the pre-trained recommendation model is used to predict, when the user pays attention to a target recommended commodity, a probability that the user selects the target recommended object, and the sample label is used to indicate whether the user selects a sample recommended object.

The pre-trained recommendation model may be the actual user selection rate fitting module 502 shown in FIG. 6 or FIG. 7. A recommendation model training method may be the training method shown in FIG. 5 and the method in the offline training phase shown in FIG. 7. Details are not described herein again.

A model parameter of the pre-trained recommendation model is obtained by performing joint training on a position aware model and the recommendation model by using a sample user behavior log and position information of the sample recommended object as input data and using a sample label as a target output value. The position aware model is used to predict probabilities that the user pays attention to the target recommended object when the target recommended object is at different positions.

Optionally, the joint training may be training model parameters of the position aware model and the recommendation model based on a difference between the sample label and a jointly predicted selection probability, and the jointly predicted selection probability is obtained based on output data of the position aware model and the recommendation model.

For example, a training sample may be obtained, where the training sample may include the sample user behavior log, the position information of the sample recommended object, and the sample label; the position information of the sample recommended object may be input into the position aware model to obtain the probability that the user pays attention to the target recommended object; and the sample user behavior log may be input into the recommendation model to obtain the probability that the user selects the target recommended commodity; and the jointly predicted selection probability may be obtained by multiplying the probability that the user pays attention to the target recommended object by the probability that the user selects the target recommended commodity.

Step 603: Obtain a recommendation result of the candidate recommended object based on the probability that the to-be-processed user selects the candidate recommended object.

Optionally, any candidate recommended object in the candidate recommended object set may be arranged based on a predicted probability that the user selects the candidate recommended object, to obtain a recommendation result of the candidate recommended object.

For example, candidate recommended objects may be arranged in descending order of obtained predicted selection probabilities. For example, the candidate recommended objects may be candidate recommended APPs.

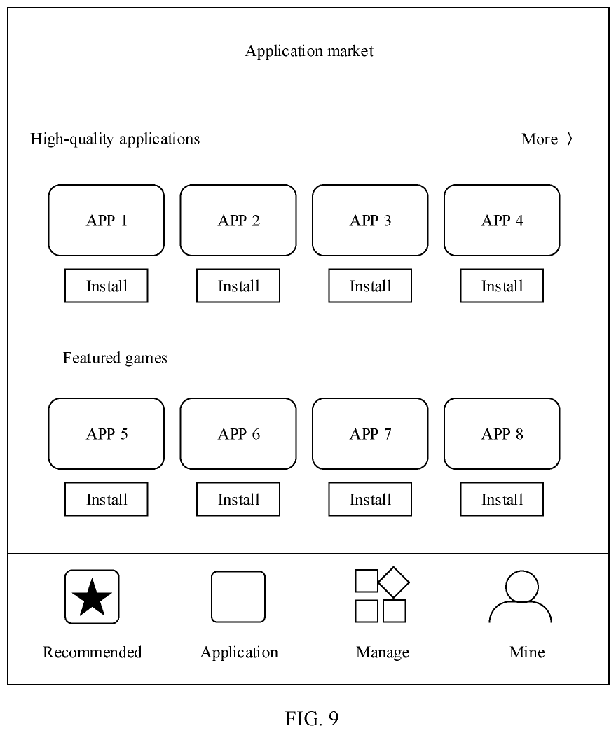

FIG. 9 shows a “recommendation” page in an application market. There may be a plurality of top lists on the page. For example, the top lists may include a top list of high-quality applications and a top list of featured games. Taking the high-quality application as an example. A recommendation system of the application market predicts, based on a user characteristic, characteristics of commodities in a candidate set, and a context characteristic, probabilities that a user selects the commodities in the candidate set, and arranges the candidate commodities in descending order of the probabilities, to arrange, at the most front, an application that is most likely to be downloaded.

For example, a recommendation result of the high-quality applications may be that an app 5 is located at a recommendation position 1 in the featured games, an app 6 is located at a recommendation position 2 in the featured games, an app 7 is located at a recommendation position 3 in the featured games, and an app 8 is located at a recommendation position 4 in the featured games. After the user sees the recommendation result of the application market, the user may choose to perform an operation such as browsing, selection, or downloading based on interests and hobbies of the user. The user operation is stored in a user behavior log after being performed.

For example, in the application market shown in FIG. 9, a recommendation model may be trained by using the user behavior log as training data.

It should be understood that the foregoing example descriptions are intended to help a person skilled in the art understand embodiments of this application, but are not intended to limit embodiments of this application to a specific value or a specific scenario in the examples. A person skilled in the art definitely can make various equivalent modifications or changes according to the examples described above, and the modifications or changes also fall within the scope of embodiments of this application.

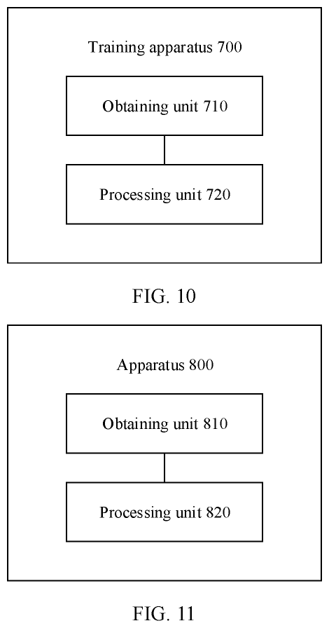

With reference to FIG. 1 to FIG. 9, the foregoing describes the recommendation model training method and the selection probability prediction method in embodiments of this application in detail. With reference to FIG. 10 to FIG. 13, the following describes apparatus embodiments of this application in detail.

It should be understood that a training apparatus in embodiments of this application may perform the foregoing recommendation model training method in embodiments of this application, and a selection probability prediction apparatus may perform the foregoing selection probability prediction method in embodiments of this application. In other words, for specific working processes of the following products, refer to corresponding processes in the foregoing method embodiments.

FIG. 10 is a schematic block diagram of a recommendation model training apparatus according to an embodiment of this application. It should be understood that a training apparatus 700 may perform the recommendation model training method shown in FIG. 5. The training apparatus 700 includes an obtaining unit 710 and a processing unit 720.

The obtaining unit 710 is configured to obtain a training sample. The training sample includes a sample user behavior log, position information of a sample recommended object, and a sample label, and the sample label is used to indicate whether a user selects the sample recommended object. The processing unit 720 is configured to perform joint training on a position aware model and a recommendation model by using the sample user behavior log and the position information of the sample recommended object as input data and using the sample label as a target output value, to obtain a trained recommendation model. The position aware model is used to predict probabilities that the user pays attention to a target recommended object when the target recommended object is at different positions, and the recommendation model is used to predict, when the user pays attention to the target recommended object, a probability that the user selects the target recommended object.

Optionally, in an embodiment, the joint training is training model parameters of the position aware model and the recommendation model based on a difference between the sample label and a jointly predicted selection probability, and the jointly predicted selection probability is obtained based on output data of the position aware model and the recommendation model.

Optionally, in an embodiment, the processing unit 720 is further configured to: input the position information of the sample recommended object into the position aware model to obtain the probability that the user pays attention to the target recommended object; input the sample user behavior log into the recommendation model to obtain the probability that the user selects the target recommended commodity; and obtain the jointly predicted selection probability by multiplying the probability that the user pays attention to the target recommended object by the probability that the user selects the target recommended commodity.

Optionally, in an embodiment, the sample user behavior log includes one or more of sample user profile information, characteristic information of the sample recommended object, and sample context information.

Optionally, in an embodiment, the position information of the sample recommended object is recommendation position information of the sample recommended object in different types of historical recommended commodities, or the position information of the sample recommended object is recommendation position information of the sample recommended object in a same type of historical recommended commodity, or the position information of the sample recommended object is recommendation position information of the sample recommended object in historical recommended commodities in different top lists.

FIG. 11 is a schematic block diagram of a selection probability prediction apparatus according to an embodiment of this application. It should be understood that an apparatus 800 may perform the selection probability prediction method shown in FIG. 8. The apparatus 800 includes an obtaining unit 810 and a processing unit 820.

The obtaining unit 810 is configured to obtain user characteristic information of a to-be-processed user, context information, and a candidate recommended commodity set. The processing unit 820 is configured to: input the user characteristic information, the context information, and the candidate recommended object set into a pre-trained recommendation model to obtain a probability that the to-be-processed user selects a candidate recommended object in the candidate recommended object set, where the pre-trained recommendation model is used to predict, when the user pays attention to a target recommended commodity, a probability that the user selects the target recommended object; and obtain a recommendation result of the candidate recommended object based on the probability that the to-be-processed user selects the candidate recommended object, where a model parameter of the pre-trained recommendation model is obtained by performing joint training on a position aware model and the recommendation model by using a sample user behavior log and position information of a sample recommended object as input data and using a sample label as a target output value, the position aware model is used to predict probabilities that the user pays attention to the target recommended object when the target recommended object is at different positions, and the sample label is used to indicate whether the user selects the sample recommended object.

Optionally, any candidate recommended object in the candidate recommended object set may be arranged based on a predicted probability that the user selects the candidate recommended object, to obtain a recommendation result of the candidate recommended object.

Optionally, in an embodiment, the joint training is training model parameters of the position aware model and the recommendation model based on a difference between the sample label and a jointly predicted selection probability, and the jointly predicted selection probability is obtained based on output data of the position aware model and the recommendation model.

Optionally, in an embodiment, the jointly predicted selection probability is obtained by multiplying the probability that the user pays attention to the target recommended object by the probability that the user selects the target recommended object, the probability that the user pays attention to the target recommended object is obtained based on the position information of the sample recommended object and the position aware model, and the probability that the user selects the target recommended object is obtained based on the sample user behavior and the recommendation model.

Optionally, in an embodiment, the sample user behavior log includes one or more of sample user profile information, characteristic information of the sample recommended object, and sample context information.

Optionally, in an embodiment, the position information of the sample recommended object is recommendation position information of the sample recommended object in different types of recommended objects, or the position information of the sample recommended object is recommendation position information of the sample recommended object in a same type of recommended object, or the position information of the sample recommended object is recommendation position information of the sample recommended object in recommended objects in different top lists.

It should be noted that the training apparatus 700 and the apparatus 800 are embodied in a form of functional units. The term “unit” herein may be implemented in a form of software and/or hardware. This is not specifically limited.

For example, “unit” may be a software program, a hardware circuit, or a combination thereof that implements the foregoing functions. The hardware circuit may include an application-specific integrated circuit (application-specific integrated circuit, ASIC), an electronic circuit, a processor (for example, a shared processor, a dedicated processor, or a group processor) and a memory that are configured to execute one or more software or firmware programs, a merged logic circuit, and/or another suitable component that supports the described functions.

Therefore, the units in the examples described in embodiments of this application can be implemented by electronic hardware or a combination of computer software and electronic hardware. Whether the functions are performed by hardware or software depends on particular applications and design constraints of the technical solutions. A person skilled in the art may use different methods to implement the described functions of each particular application, but it should not be considered that the implementation goes beyond the scope of this application.

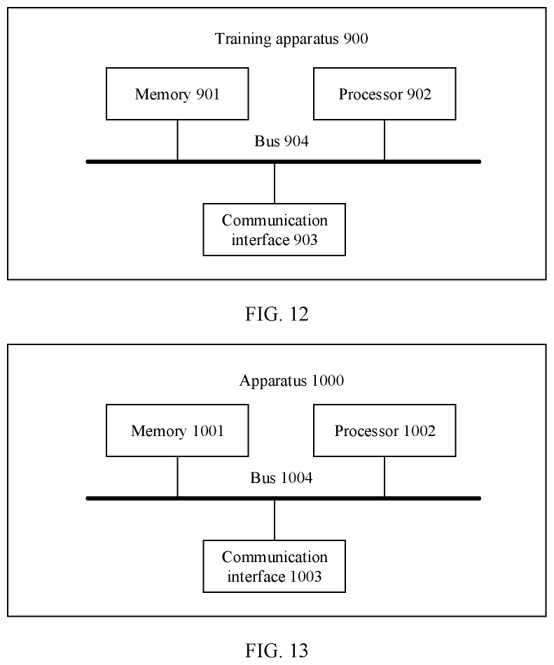

FIG. 12 is a schematic diagram of a hardware structure of a recommendation model training apparatus according to an embodiment of this application. The training apparatus 900 (the apparatus 900 may be specifically a computer device) shown in FIG. 12 includes a memory 901, a processor 902, a communication interface 903, and a bus 904. A communication connection between the memory 901, the processor 902, and the communication interface 903 is implemented by using the bus 904.

The memory 901 may be a read-only memory (read-only memory, ROM), a static storage device, a dynamic storage device, or a random access memory (random access memory, RAM). The memory 901 may store a program. When the program stored in the memory 901 is executed by the processor 902, the processor 902 is configured to perform steps of the recommendation model training method in embodiments of this application, for example, perform the steps shown in FIG. 5.

It should be understood that the training apparatus in this embodiment of this application may be a server, for example, may be a server on the cloud, or may be a chip configured on a server on the cloud.

The processor 902 may be a general-purpose central processing unit (central processing unit, CPU), a microprocessor, an application-specific integrated circuit (application specific integrated circuit, ASIC), a graphics processing unit (graphics processing unit, GPU), or one or more integrated circuits, and is configured to execute a related program, to implement the recommendation model training method in the method embodiments of this application.

Alternatively, the processor 902 may be an integrated circuit chip, and has a signal processing capability. During implementation, steps of the recommendation model training method in this application may be completed by using an integrated logic circuit of hardware in the processor 902 or instructions in a form of software.

Alternatively, the processor 902 may be a general-purpose processor, a digital signal processor (digital signal processor, DSP), an application-specific integrated circuit (ASIC), a field programmable gate array (field programmable gate array, FPGA) or another programmable logic device, a discrete gate or a transistor logic device, or a discrete hardware component. The methods, the steps, and logic block diagrams that are disclosed in embodiments of this application may be implemented or performed. The general-purpose processor may be a microprocessor, or the processor may be any conventional processor or the like. Steps of the methods disclosed with reference to embodiments of this application may be directly executed and accomplished by a hardware decoding processor, or may be executed and accomplished by using a combination of hardware and software modules in a decoding processor. The software module may be located in a storage medium mature in the art, such as a random access memory, a flash memory, a read-only memory, a programmable read-only memory, an electrically erasable programmable memory, or a register. The storage medium is located in the memory 901. The processor 902 reads information in the memory 901, and completes, in combination with hardware of the processor 902, a function that needs to be performed by a unit included in the training apparatus shown in FIG. 10 in embodiments of this application, or performs the recommendation model training method shown in FIG. 5 in the method embodiments of this application.

The communication interface 903 uses a transceiver apparatus, for example but not for limitation, a transceiver, to implement communication between the training apparatus 900 and another device or a communication network.

The bus 904 may include a path for transmitting information between the components (for example, the memory 901, the processor 902, and the communication interface 903) of the training apparatus 900.

FIG. 13 is a schematic diagram of a hardware structure of a selection probability prediction apparatus according to an embodiment of this application. The apparatus 1000 (the apparatus 1000 may be specifically a computer device) shown in FIG. 13 includes a memory 1001, a processor 1002, a communication interface 1003, and a bus 1004. The memory 1001, the processor 1002, and the communication interface 1003 are communicatively connected to each other through the bus 1004.

The memory 1001 may be a read-only memory (read-only memory, ROM), a static storage device, a dynamic storage device, or a random access memory (random access memory, RAM). The memory 1001 may store a program. When the program stored in the memory 1001 is executed by the processor 1002, the processor 1002 is configured to perform steps of the selection probability prediction method in embodiments of this application, for example, perform the steps shown in FIG. 8.

It should be understood that the apparatus in this embodiment of this application may be an intelligent terminal, or may be a chip configured on an intelligent terminal.

The processor 1002 may be a general-purpose central processing unit (central processing unit, CPU), a microprocessor, an application-specific integrated circuit (application specific integrated circuit, ASIC), a graphics processing unit (graphics processing unit, GPU), or one or more integrated circuits, and is configured to execute a related program, to implement the selection probability prediction method in the method embodiments of this application.

Alternatively, the processor 1002 may be an integrated circuit chip, and has a signal processing capability. During implementation, steps of the selection probability prediction method in this application may be completed by using an integrated logic circuit of hardware in the processor 1002 or instructions in a form of software.

Alternatively, the processor 1002 may be a general-purpose processor, a digital signal processor (digital signal processor, DSP), an application-specific integrated circuit (ASIC), a field programmable gate array (field programmable gate array, FPGA) or another programmable logic device, a discrete gate or a transistor logic device, or a discrete hardware component. The methods, the steps, and logic block diagrams that are disclosed in embodiments of this application may be implemented or performed. The general-purpose processor may be a microprocessor, or the processor may be any conventional processor or the like. Steps of the methods disclosed with reference to embodiments of this application may be directly executed and accomplished by a hardware decoding processor, or may be executed and accomplished by using a combination of hardware and software modules in a decoding processor. The software module may be located in a storage medium mature in the art, such as a random access memory, a flash memory, a read-only memory, a programmable read-only memory, an electrically erasable programmable memory, or a register. The storage medium is located in the memory 1001. The processor 1002 reads information in the memory 1001, and completes, in combination with hardware of the processor 1002, a function that needs to be performed by a unit included in the apparatus shown in FIG. 11 in embodiments of this application, or performs the selection probability prediction method shown in FIG. 8 in the method embodiments of this application.

The communication interface 1003 uses a transceiver apparatus, for example but not for limitation, a transceiver, to implement communication between the apparatus 1000 and another device or a communication network.

The bus 1004 may include a path for transmitting information between the components (for example, the memory 1001, the processor 1002, and the communication interface 1003) of the apparatus 1000.

It should be noted that, although only the memory, the processor, and the communication interface are shown in each of the training apparatus 900 and the apparatus 1000, in a specific implementation process, a person skilled in the art should understand that the training apparatus 900 and the apparatus 1000 each may further include another component necessary for normal running. In addition, based on a specific requirement, a person skilled in the art should understand that the training apparatus 900 and the apparatus 1000 each may further include a hardware component for implementing another additional function. In addition, a person skilled in the art should understand that the training apparatus 900 and the apparatus 1000 each may include only components necessary for implementing embodiments of this application, but not necessarily include all the components shown in FIG. 12 or FIG. 13.

It should be further understood that, in embodiments of this application, the memory may include a read-only memory and a random access memory, and provide instructions and data for the processor. A part of the processor may further include a non-volatile random access memory. For example, the processor may further store information of a device type.

It should be understood that, the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with units and algorithm steps in the examples described in embodiments disclosed in this specification, embodiments may be implemented by electronic hardware or a combination of computer software and electronic hardware. Whether the functions are performed by hardware or software depends on particular applications and design constraints of the technical solutions. A person skilled in the art may use different methods to implement the described functions of each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, function modules in embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes instructions for instructing a computer device (which may be a personal computer, a server, a network device, or the like) to perform all or some of the steps of the method described in embodiments of this application. The storage medium includes any medium that can store program code such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A recommendation model training method implemented by a computer device, comprising:
obtaining a training sample, wherein the training sample comprises a sample user behavior log, position information of a sample recommended object, and a sample label, and wherein the sample label indicates whether a user selects the sample recommended object; and
performing joint training on a position aware model and a recommendation model by using the sample user behavior log and the position information of the sample recommended object as input data and using the sample label as a target output value, to obtain a trained recommendation model, wherein the position aware model predicts probabilities that the user pays attention to a target recommended object when the target recommended object is at different positions, and the recommendation model predicts, when the user pays attention to the target recommended object, a probability that the user selects the target recommended object.

2. The recommendation model training method according to claim 1, wherein the joint training is training model parameters of the position aware model and the recommendation model based on a difference between the sample label and a jointly predicted selection probability, and wherein the jointly predicted selection probability is obtained based on output data of the position aware model and the recommendation model.

3. The recommendation model training method according to claim 2, further comprising:
inputting the position information of the sample recommended object into the position aware model to obtain the probability that the user pays attention to the target recommended object;
inputting the sample user behavior log into the recommendation model to obtain the probability that the user selects the target recommended object; and
obtaining the jointly predicted selection probability by multiplying the probability that the user pays attention to the target recommended object by the probability that the user selects the target recommended object.

4. The recommendation model training method according to claim 1, wherein the sample user behavior log comprises one or more of sample user profile information, characteristic information of the sample recommended object, or sample context information.

5. The recommendation model training method according to claim 1, wherein the position information of the sample recommended object is recommendation position information of the sample recommended object in different types of recommended objects, or the position information of the sample recommended object is recommendation position information of the sample recommended object in a same type of recommended object, or the position information of the sample recommended object is recommendation position information of the sample recommended object in recommended objects in different top lists.

6. A selection probability prediction method implemented by a computer device, comprising:
obtaining user characteristic information of a to-be-processed user, context information, and a candidate recommended object set;
inputting the user characteristic information, the context information, and the candidate recommended object set into a pre-trained recommendation model to obtain a probability that the to-be-processed user selects a candidate recommended object in the candidate recommended object set, wherein the pre-trained recommendation model is used to predict, when the user pays attention to a target recommended object, a probability that the user selects the target recommended object; and
obtaining a recommendation result of the candidate recommended object based on the probability that the to-be-processed user selects the candidate recommended object, wherein a model parameter of the pre-trained recommendation model is obtained by performing joint training on a position aware model and the recommendation model by using a sample user behavior log and position information of a sample recommended object as input data and using a sample label as a target output value, wherein the position aware model predicts probabilities that the user pays attention to the target recommended object when the target recommended object is at different positions, and the sample label indicates whether the user selects the sample recommended object.

7. The selection probability prediction method according to claim 6, wherein the joint training is training model parameters of the position aware model and the recommendation model based on a difference between the sample label and a jointly predicted selection probability, and wherein the jointly predicted selection probability is obtained based on output data of the position aware model and the recommendation model.

8. The selection probability prediction method according to claim 6, wherein the jointly predicted selection probability is obtained by multiplying the probability that the user pays attention to the target recommended object by the probability that the user selects the target recommended object, wherein the probability that the user pays attention to the target recommended object is obtained based on the position information of the sample recommended object and the position aware model, and wherein the probability that the user selects the target recommended object is obtained based on the sample user behavior and the recommendation model.

9. The selection probability prediction method according to claim 6, wherein the sample user behavior log comprises one or more of sample user profile information, characteristic information of the sample recommended object, or sample context information.

10. The selection probability prediction method according to claim 6, wherein the position information of the sample recommended object is recommendation position information of the sample recommended object in different types of recommended objects, or the position information of the sample recommended object is recommendation position information of the sample recommended object in a same type of recommended object, or the position information of the sample recommended object is recommendation position information of the sample recommended object in recommended objects in different top lists.

11. A recommendation model training apparatus, comprising:
at least one processor; and
a memory coupled to the at least one processor, wherein the at least one processor is configured to read and execute instructions in the memory, to cause the recommendation model training apparatus to perform steps of:
obtaining a training sample, wherein the training sample comprises a sample user behavior log, position information of a sample recommended object, and a sample label, and wherein the sample label indicates whether a user selects the sample recommended object; and
performing joint training on a position aware model and a recommendation model by using the sample user behavior log and the position information of the sample recommended object as input data and using the sample label as a target output value, to obtain a trained recommendation model, wherein the position aware model predicts probabilities that the user pays attention to a target recommended object when the target recommended object is at different positions, and wherein the recommendation model predicts, when the user pays attention to the target recommended object, a probability that the user selects the target recommended object.

12. The recommendation model training apparatus according to claim 11, wherein the joint training is training model parameters of the position aware model and the recommendation model based on a difference between the sample label and a jointly predicted selection probability, and the jointly predicted selection probability is obtained based on output data of the position aware model and the recommendation model.

13. The recommendation model training apparatus according to claim 12, wherein the at least one processor is further configured to read and execute the instructions in the memory, to cause the recommendation model training apparatus to perform steps of:
inputting the position information of the sample recommended object into the position aware model to obtain the probability that the user pays attention to the target recommended object;
inputting the sample user behavior log into the recommendation model to obtain the probability that the user selects the target recommended object; and
obtaining the jointly predicted selection probability by multiplying the probability that the user pays attention to the target recommended object by the probability that the user selects the target recommended object.

14. The recommendation model training apparatus according to claim 13, wherein the sample user behavior log comprises one or more of sample user profile information, characteristic information of the sample recommended object, or sample context information.

15. The recommendation model training apparatus according to claim 11, wherein the position information of the sample recommended object is recommendation position information of the sample recommended object in different types of recommended objects, or the position information of the sample recommended object is recommendation position information of the sample recommended object in a same type of recommended object, or the position information of the sample recommended object is recommendation position information of the sample recommended object in recommended objects in different top lists.

16. A recommendation apparatus, comprising:
at least one processor: and
a memory coupled to the at least one processor, wherein the at least one processor is configured to read and execute instructions in the memory, to cause the recommendation apparatus to perform steps of:
obtaining user characteristic information of a to-be-processed user, context information, and a candidate recommended object set;
inputting the user characteristic information, the context information, and the candidate recommended object set into a pre-trained recommendation model to obtain a probability that the to-be-processed user selects a candidate recommended object in the candidate recommended object set, wherein the pre-trained recommendation model predicts, when the to-be-processed user pays attention to a target recommended object, a probability that the to-be-processed user selects the target recommended object; and
obtaining a recommendation result of the candidate recommended object based on the probability that the to-be-processed user selects the candidate recommended object, wherein a model parameter of the pre-trained recommendation model is obtained by performing joint training on a position aware model and the recommendation model by using a sample user behavior log and position information of a sample recommended object as input data and using a sample label as a target output value, wherein the position aware model predicts probabilities that the to-be-processed user pays attention to the target recommended object when the target recommended object is at different positions, and wherein the sample label indicates whether the to-be-processed user selects the sample recommended object.

17. The recommendation apparatus according to claim 16, wherein the joint training is training model parameters of the position aware model and the recommendation model based on a difference between the sample label and a jointly predicted selection probability, and the jointly predicted selection probability is obtained based on output data of the position aware model and the recommendation model.

18. The recommendation apparatus according to claim 16, wherein the jointly predicted selection probability is obtained by multiplying the probability that the to-be-processed user pays attention to the target recommended object by the probability that the to-be-processed user selects the target recommended object, wherein the probability that the to-be-processed user pays attention to the target recommended object is obtained based on the position information of the sample recommended object and the position aware model, and wherein the probability that the to-be-processed user selects the target recommended object is obtained based on the sample user behavior and the recommendation model.

19. The recommendation apparatus according to claim 16, wherein the sample user behavior log comprises one or more of sample user profile information, characteristic information of the sample recommended object, or sample context information.

20. The recommendation apparatus according to claim 16, wherein the position information of the sample recommended object is recommendation position information of the sample recommended object in different types of recommended objects, or the position information of the sample recommended object is recommendation position information of the sample recommended object in a same type of recommended object, or the position information of the sample recommended object is recommendation position information of the sample recommended object in recommended objects in different top lists.
